(19) United States
(12) Patent Application Publication
(10) Pub. No.: US 2026/0368139 A1
(43) Pub. Date: Nov. 19, 2026

(54) DATA MERGING METHOD AND APPARATUS BASED ON FILE STORAGE, AND DEVICE AND MEDIUM

(71) Applicant: Beijing Zitiao Network Technology Co., Ltd., Beijing (CN)

(72) Inventors: Yangfeng TIAN, Beijing (CN); Jie WANG, Beijing (CN); Xiaodong LUO, Beijing (CN)

(21) Appl. No.: 19/433,344

(22) Filed: Dec. 26, 2025

(30) Foreign Application Priority Data
May 19, 2025 (CN) 202510646465.2

(51) Int. Cl. G06F 16/17; G06F 7/14; G06F 16/13

(52) U.S. Cl. CPC G06F 16/1724; G06F 7/14; G06F 16/13

(57) ABSTRACT

Embodiments of the present disclosure relate to a data merging method and apparatus based on file storage, and a device and a medium. The method includes: obtaining specified information about each of multiple first log files in a first sub-interval of a target storage unit, where the target storage unit has one layer of address space, the one layer of address space is divided into the first sub-interval and a second sub-interval, the first sub-interval is used for storing, through the first log files, data corresponding to write operations, and the second sub-interval is used for storing, through second log files, valid data obtained after merging processing is performed on data in the first sub-interval; selecting a first target file from the multiple first log files based on the specified information about each of the multiple first log files; performing merging processing on data in the first target file to obtain first valid data; and writing the first valid data into a second log file in the second sub-interval.

### CROSS REFERENCE TO RELATED APPLICATIONS

This present application claims the benefit of priority to Chinese Application No. 202510646465.2, filed on May 19, 2025, the entire contents of which are incorporated herein by reference.

### TECHNICAL FIELD

The present disclosure relates to the field of data processing technologies and, in particular, to a data merging method and apparatus based on file storage, and a device and a medium.

### BACKGROUND

Data storage is widely used in various fields, such as network file storage involved in massive data scenarios such as large model training. A merging technology may sort out fragmented data, clear invalid data, and re-store valid data in order. As a key optimization means, the merging technology may effectively improve storage performance and resource utilization.

### SUMMARY

The present disclosure provides a data merging method and apparatus based on file storage, and a device and a medium.

An embodiment of the present disclosure provides a data merging method based on file storage. The method includes: obtaining specified information about each of multiple first log files in a first sub-interval of a target storage unit, where the target storage unit has one layer of address space, the one layer of address space is divided into the first sub-interval and a second sub-interval, the first sub-interval is used for storing, through the first log files, data corresponding to write operations, and the second sub-interval is used for storing, through second log files, valid data obtained after merging processing is performed on data in the first sub-interval; selecting a first target file from the multiple first log files based on the specified information about each of the multiple first log files; performing merging processing on data in the first target file to obtain first valid data; and writing the first valid data into a second log file in the second sub-interval.

Optionally, the specified information includes a garbage rate, a degree of data dispersion, or an access frequency.

Optionally, in a case where the specified information includes the garbage rate, the obtaining specified information about each of multiple first log files in a first sub-interval of a target storage unit includes: determining, based on a pre-obtained global index corresponding to the target storage unit, total length of invalid intervals corresponding to each of the multiple first log files in the first sub-interval of the target storage unit; and for each of the multiple first log files, obtaining a garbage rate corresponding to the first log file according to a ratio of the total length of invalid intervals corresponding to the first log file to a total length of an address interval corresponding to the first log file.

Optionally, the selecting a first target file from the multiple first log files based on the specified information about the multiple first log files includes: based on a value corresponding to the specified information about each of the multiple first log files, selecting, from the multiple first log files, first N first log files with the highest values corresponding to the specified information as the first target file, or selecting, from the multiple first log files, a first log file with a value corresponding to the specified information higher than a preset threshold as the first target file, where N is a preset positive integer.

Optionally, the performing merging processing on data in the first target file to obtain first valid data includes: eliminating invalid data in the first target file based on a pre-obtained global index corresponding to the target storage unit to obtain the first valid data of the first target file.

Optionally, the writing the first valid data into a second log file in the second sub-interval includes: performing interval aggregation on multiple segments of address intervals of first valid data corresponding to a same user file in the first target file, so that each user file included in the first target file corresponds to only one segment of address interval of first valid data, and address intervals corresponding to different user files are different; and writing first valid data corresponding to each user file included in the first target file into the second log file in the second sub-interval.

Optionally, the method further includes: obtaining specified information about each existing second log file in the second sub-interval; selecting a second target file from the existing second log files based on the specified information about each of the existing second log files; performing merging processing on data in the second target file to obtain second valid data; and writing the second valid data into a latest created second log file in the second sub-interval.

Optionally, an interval length corresponding to the first sub-interval is the same as an interval length corresponding to the second sub-interval.

An embodiment of the present disclosure further provides a data merging apparatus based on file storage. The apparatus includes: a specified information obtaining module configured to obtain specified information about each of multiple first log files in a first sub-interval of a target storage unit, where the target storage unit has one layer of address space, the one layer of address space is divided into the first sub-interval and a second sub-interval, the first sub-interval is used for storing, through the first log files, data corresponding to write operations, and the second sub-interval is used for storing valid data obtained after merging processing is performed on data in the first sub-interval; a target file selection module configured to select a first target file from the multiple first log files based on the specified information about each of the multiple first log files; a data merging processing module configured to perform merging processing on data in the first target file to obtain first valid data; and a valid data writing module configured to write the first valid data into a second log file in the second sub-interval.

An embodiment of the present disclosure further provides an electronic device. The electronic device includes: a processor; and a memory configured to store instructions that may be executed by the processor, where the processor is configured to read the instructions from the memory, and execute the instructions to implement the data merging method according to the embodiments of the present disclosure.

An embodiment of the present disclosure further provides a computer-readable storage medium storing a computer program, where the computer program is used to perform the data merging method based on file storage according to the embodiments of the present disclosure.

An embodiment of the present disclosure further provides a computer program product including a computer program, where the computer program, when executed by a processor, implements the data merging method based on file storage according to the embodiments of the present disclosure.

It should be understood that content described in this section is neither intended to identify key or important features of the embodiments of the present disclosure, nor is used to limit the scope of the present disclosure. Other features of the present disclosure become easy to understand through the following description.

### BRIEF DESCRIPTION OF THE DRAWINGS

The drawings herein, which are incorporated in and constitute a part of this specification, illustrate embodiments consistent with the present disclosure, and together with the description, serve to explain the principles of the present disclosure.

To describe the technical solutions in the embodiments of the present disclosure or in the related art more clearly, the following briefly introduces drawings required for describing the embodiments or the related art. Apparently, a person of ordinary skill in the art may still derive other drawings from these drawings without creative efforts.

FIG. 1 is a schematic flowchart of a data merging method based on file storage according to an embodiment of the present disclosure;

FIG. 2 is a schematic diagram of a storage unit structure according to an embodiment of the present disclosure;

FIG. 3 is a schematic flowchart of a data merging method based on file storage according to an embodiment of the present disclosure;

FIG. 4 is a schematic diagram of data merging according to an embodiment of the present disclosure;

FIG. 5 is a schematic diagram of a structure of a data merging apparatus based on file storage according to an embodiment of the present disclosure; and

FIG. 6 is a schematic diagram of a structure of an electronic device according to an embodiment of the present disclosure.

### DETAILED DESCRIPTION OF EMBODIMENTS

To understand the above objectives, features, and advantages of the present disclosure more clearly, the solutions of the present disclosure are further described below. It should be noted that the embodiments of the present disclosure and features in the embodiments may be combined with each other without conflict.

Many specific details are set forth in the following description to facilitate full understanding of the present disclosure, but the present disclosure may also be implemented in other ways different from those described herein. Apparently, the described embodiments are part, not all, of the embodiments of the present disclosure.

The defects existing in the solutions in the related art are obtained by the applicant through practice and careful study. Therefore, the process of discovering the above defects and the solutions to the above defects proposed in the embodiments of the present disclosure below should be considered as contributions of the applicant to the present application.

A current mainstream storage mode adopts a log-structured file system (LFS), but the inventors have found that a storage unit structure of the system is poor, resulting in poor flexibility of data merging and low merging efficiency. A traditional log-structured file system adopts multi-layer address space, and data merging may be performed only from front to back in each layer of address space, and the problem of flipping between different layers of address space is also involved. Specifically, a logical storage unit in the traditional log file system has three layers of address space, which may also be referred to as having three layers of structures, namely, sibling0, sibling1, and sibling2. The three layers of address space have a hierarchical relationship from top to bottom, and each layer of address space is used to manage an independent log file, where sibling0 carries a write request from a foreground user. After a garbage rate of an upper layer of address space reaches a threshold, several log files are merged in a front-to-back order, and then valid data obtained after merging is written into a lower layer of address space. Since data merging processing for each layer of address space may select log files only from front to back, some log files with a high garbage rate and located at the back cannot be merged in time, affecting data merging efficiency.

In addition, when performing data merging processing for each layer of address space, the traditional log-structured file system locally determines whether data is valid only from some selected log files, and there may still be the case that garbage data is written into the lower layer of address space. For example, a log file 1 stored in sibling0 includes written data A, B, A′, B′, A″, C, and D, where A′ is data overwriting A, A″ is data overwriting A′, and B′ is data overwriting B. First, first data merging processing is performed for the log file 1 of sibling0, and obtained A″, B′, C, and D are written into a log file 2 in sibling1. Data E, F, and D′ are written into a log file 2 in sibling0, where D′ is data overwriting D. The first data merging processing is performed only for the log file 1, and then second data merging processing is performed for the log file 2 of sibling0, and E, F, and D′ are written into the log file 2 in sibling1. At this time, both D and D′ sink into sibling1, resulting in redundant data, that is, garbage data D, in sibling1, and low merging efficiency. [0031] In addition, the existing structure has the problem of complex flip logic design of sibling1 and sibling2 layers. For example, since sibling2 does not have a next layer structure into which data obtained after merging processing may be written, when a garbage rate of sibling2 reaches a threshold, merging processing from sibling0 to sibling1 is stopped. After data of sibling1 is merged and written into sibling2, multiple flips of sibling1 and sibling2 layers are performed, that is, sibling0, sibling2, and sibling1 from top to bottom, so that sibling2 may write data obtained after the merging processing into sibling1. The above processing flow is not only complex, but also blocks data merging processing in sibling0 during a flipping process, resulting in untimely data merging processing in sibling0 and affecting overall data merging efficiency. In conclusion, the existing log-structured file system has a poor structure, resulting in low data merging efficiency. To solve this problem, embodiments of the present disclosure provide a data merging method and apparatus based on file storage, and a device and a medium, which are described in detail below.

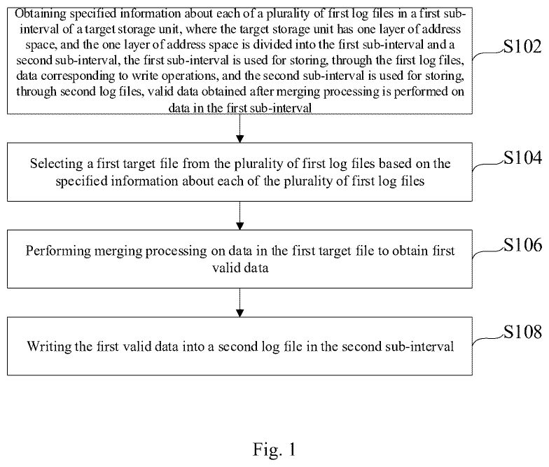

FIG. 1 is a schematic flowchart of a data merging method based on file storage according to an embodiment of the present disclosure. The method may be performed by a data merging apparatus, which may be implemented in software and/or hardware and may generally be integrated into an electronic device. As shown in FIG. 1, the method mainly includes the following steps S102 to S108.
Step S102: obtaining specified information about each of multiple first log files in a first sub-interval of a target storage unit, where the target storage unit has one layer of address space, the one layer of address space is divided into the first sub-interval and a second sub-interval, the first sub-interval is used for storing, through the first log files, data corresponding to write operations, and the second sub-interval is used for storing, through second log files, valid data obtained after merging processing is performed on data in the first sub-interval.

The target storage unit is a logical storage unit. Compared with the logical storage unit in the related art, which has three layers of address space from top to bottom, an embodiment of the present disclosure proposes a target storage unit adopting a new storage structure. The target storage unit has only one layer of address space, and the address space is divided into two sub-intervals. In practical applications, a ratio of an interval length of the first sub-interval to a total length of the address space is a first ratio, and a ratio of an interval length of the second sub-interval to the total length of the address space is a second ratio. A sum of the first ratio and the second ratio is 1. The first ratio and the second ratio may be flexibly set as required. For example, the first ratio and the second ratio are both 0.5. In other words, in some examples, the one layer of address space may be equally divided into the first sub-interval and the second sub-interval. An interval length corresponding to the first sub-interval is the same as an interval length corresponding to the second sub-interval, to ensure that the first sub-interval and the second sub-interval have equal interval lengths to perform corresponding tasks. For example, if a range of the one layer of address space is 0 to a unit64 maximum value, an interval range of the first sub-interval is 0 to the unit64 maximum value/2, and an interval range of the second sub-interval is the unit64 maximum value/2 to a uint64 maximum value.

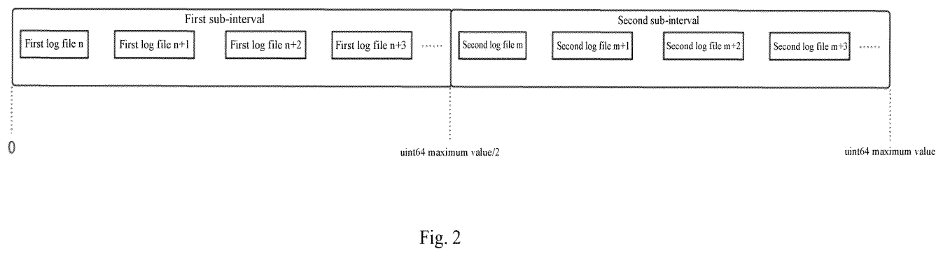

For ease of understanding, reference may also be made to the schematic diagram of a storage unit structure shown in FIG. 2, which shows that a target storage unit having only one layer of address space is equally divided into a first sub-interval and a second sub-interval. The first sub-interval shows multiple first log files, and the second sub-interval shows multiple second log files. The first sub-interval and the second sub-interval perform data storage through the log files. It should be noted that FIG. 2 is merely an example. In practical applications, an interval range of the target storage unit may be flexibly set as required, and lengths of the first sub-interval and the second sub-interval may be the same or different, which may be specifically and flexibly set and is not limited herein.

The target storage unit having one layer of address space has a more streamlined structure, is easy to implement, and no longer needs to flip structures of different layers, which not only greatly simplifies data merging logic, but also avoids the problem in the related art that data merging processing is blocked due to flipping, and may effectively ensure timeliness of the data merging processing and data merging efficiency. In addition, the first sub-interval and the second sub-interval have different main functions. The first sub-interval is mainly used for storing data corresponding to write operations, and it may also be said that the first sub-interval is mainly used for foreground input/output (IO), and the second sub-interval is mainly used for storing valid data obtained after the merging processing is performed on the data in the first sub-interval. Both the first sub-interval and the second sub-interval may also be used to respond to read requests and provide data corresponding to the read requests, that is, they may function as conventional storage units, which will not be repeated herein. The process of foreground IO corresponding to the first sub-interval and the process of writing merged data corresponding to the second sub-interval do not affect each other, and may better ensure the reliability of data read/write and data merging processing of the target storage unit.

The specified information is not limited in the embodiments of the present disclosure. The structure provided in the related art only supports selecting log files from front to back for merging processing, while the storage unit structure provided in the embodiments of the present disclosure may support selecting log files as needed. Therefore, a reference factor for determining whether a log file should be merged may be determined as needed, and a value corresponding to the reference factor may be used as the specified information. In practical applications, the specified information may be set in the direction of improving data merging efficiency. Exemplarily, the specified information includes a garbage rate, a degree of data dispersion, or an access frequency. A log file that should be preferentially merged is selected from numerous log files based on the level of the garbage rate, the level of the degree of data dispersion, or the level of the access frequency. For example, a log file with a high garbage rate is preferentially merged, a file with a high degree of data dispersion is preferentially merged, or a file with a high access frequency is preferentially merged, which facilitates further improvement of data merging efficiency and storage performance.
Step S104: selecting a first target file from the multiple first log files based on the specified information about each of the multiple first log files.

The specified information may be represented by a numerical value. On this basis, in an example, the multiple first log files may be sorted based on the specified information about each of the multiple first log files, and then first N first log files are selected as the first target file based on a sorting result. In another example, the specified information about each of the multiple first log files may be compared with a preset threshold, respectively, and a first log file higher than the threshold is used as the first target file. In practical applications, the number of the first target files may be one or more, which is not limited herein.

According to the above method, a log file to be merged does not need to be selected from front to back in sequence, but a currently suitable first target file may be selected based on the specified information, which is highly flexible and helps improve data merging efficiency.
Step S106: performing merging processing on data in the first target file to obtain first valid data. The merging processing includes: eliminating invalid data in the first target file to obtain valid data in the first target file. The invalid data includes overwritten data and deleted data. For example, the first target file includes file 1 and file 2, file 1 includes written data A, B, A′, and B′, and file 2 includes written data A″, C, and D, where A′ is data overwriting A, A″ is data overwriting A′, B′ is data overwriting B, and D is marked as deleted data. After merging processing is performed on file 1 and file 2, invalid data A, A′, B, and D are eliminated, and obtained first valid data includes: A″, B′, and C.
Step S108: writing the first valid data into a second log file in the second sub-interval. That is, the first valid data is stored in the second log file. After the first valid data is successfully written into the second log file, the first target file may be deleted from the first sub-interval.

According to the above method provided in the embodiments of the present disclosure, the target storage unit having a new storage structure is used, which not only makes the structure more streamlined, but also enables flexible selection of a required first target file for merging processing based on the specified information about each of the multiple first log files. Compared with the related art in which data merging may be performed only from front to back, the above data merging mode is more flexible, which facilitates improvement of merging efficiency. Moreover, in the above structure, valid data in the first sub-interval in the same layer of address space is written into the second sub-interval, and there is no problem like in the related art that data merging in other layers is blocked due to flipping. Compared with the related art, data merging efficiency may be effectively improved.

In some implementations, on the basis that the specified information includes the garbage rate, the above step S102, that is, the step of obtaining specified information about each of the multiple first log files in the first sub-interval of the target storage unit, may be performed with reference to the following steps (1) and (2).
Step (1): determining, based on a pre-obtained global index corresponding to the target storage unit, total length of invalid intervals corresponding to each of the multiple first log files in the first sub-interval of the target storage unit.

The target storage unit usually has a corresponding global index, and relevant data information may be learned based on the corresponding global index. The global index is presented in the form of a table, and may also be referred to as a global index table, which is used to indicate a data position mapping relationship between user files and log files in the target storage unit. For example, for data in each user file, a correspondence between an address offset of the data in the user file and an address offset of the data in a log file may be determined based on the global index. For the form of representation and the obtaining manner of the global index, reference may be made to the related art, and details are not repeated herein. If there is an overwriting or deleting operation, which address offset in the log file is overwritten or deleted is also recorded, and may be recorded in association with the global index. The overwritten or deleted address offset may be regarded as a set of invalid intervals. Therefore, through the set of invalid intervals obtained through the global index and the address interval corresponding to each first log file, an invalid interval included in the address interval corresponding to each first log file may be efficiently determined. It should be understood that the number of invalid intervals included in the address interval of each first log file may be one or more. The lengths of the multiple invalid intervals are added up to obtain the total length of invalid intervals corresponding to the first log file.
Step (2): for each of the multiple first log files, obtaining a garbage rate corresponding to the first log file according to a ratio of the total length of invalid intervals corresponding to the first log file to a total length of an address interval corresponding to the first log file.

Specifically, the above ratio may be directly used as the garbage rate. Through the above calculation method, the garbage rate of the first log file may be obtained conveniently and reliably. It should be noted that in the embodiments of the present disclosure, the total length of invalid intervals corresponding to the first log file is determined based on the global index, which is more accurate and reliable than determining an invalid interval in the log file only in a local range. On this basis, the accuracy of the garbage rate of each first log file may be fully ensured.

How to obtain the degree of data dispersion or the access frequency is not limited in the embodiments of the present disclosure. For example, the degree of data dispersion may be determined through a mapping relationship table corresponding to user file offset and log file offset. The more continuous the user data in the log file, the fewer the entries recorded in the table generally, and the lower the degree of data dispersion. The more dispersed the user data in the log file, the more entries will be recorded, and the higher the degree of data dispersion. Therefore, the degree of data dispersion of the log file may be measured based on the number of entries of user data in the log file. The above is only a simple example, and in a specific implementation, the degree of data dispersion or the access frequency may be obtained in detail with reference to the related art, which will not be repeated herein.

On the basis that the specified information includes the garbage rate, the degree of data dispersion, or the access frequency, the above step S104, that is, the step of selecting the first target file from the multiple first log files based on the specified information about each of the multiple first log files, may be performed with reference to the following method: based on a value corresponding to the specified information about each of the multiple first log files, selecting, from the multiple first log files, first N first log files with the highest values corresponding to the specified information as the first target file, or selecting, from the multiple first log files, a first log file with a value corresponding to the specified information higher than a preset threshold as the first target file, where N is a preset positive integer, which may be specifically and flexibly set as required. The value corresponding to the specified information is a specific value of the specified information, and the threshold corresponding to the specified information may be flexibly set as required. In this method, a log file with a high garbage rate, a high degree of dispersion, or a high access frequency is preferentially merged, which may effectively accelerate data merging efficiency and improve storage performance.

To further improve merging processing efficiency, on the basis of obtaining the first target file to be merged, an embodiment of the present disclosure further provides a specific implementation example of the above step S106, that is, the step of performing merging processing on data in the first target file to obtain the first valid data may be performed with reference to the following step: eliminating invalid data in the first target file based on a pre-obtained global index corresponding to the target storage unit to obtain the first valid data of the first target file. It should be noted that the related art only selects log files to be merged in sequence from front to back, and locally discriminates whether there is invalid data only for the selected log files. Therefore, there may easily be the case that some data is valid in a local range but invalid as a whole. For example, in the related art, if only log file 1 (including data A, A′, B, and C) is selected for merging processing, A in the log file 1 is regarded as invalid data, and A′, B, and C are all regarded as valid data. However, since log file 7 includes data B′, B is substantially invalid data, and the related art causes data B to be used as valid data. According to the above step provided in the embodiments of the present disclosure, the first valid data in the first log file to be merged may be calculated based on the global index, which fully ensures the reliability of the obtained first valid data, and effectively solves the problem of low merging processing efficiency caused by still using invalid data as valid data in a local range in the related art, and may further improve merging processing efficiency.

To further improve the writing efficiency of valid data and improve the subsequent reading efficiency of data of the user file in the log file, in some implementations, the above step S108, that is, the step of writing the first valid data into the second log file in the second sub-interval may be performed with reference to the following steps a and b.
Step a: performing interval aggregation on multiple segments of address intervals of first valid data corresponding to a same user file in the first target file, so that each user file included in the first target file corresponds to only one segment of address interval of first valid data.

For ease of understanding, the following is an explanation. In practical applications, one log file may include one or more user files. It is assumed that data stored in the first target file in sequence is: user file 1 [0, 4k), user file 2 [0, 4k), user file 3 [0, 4k), and user file 1 [4k, 8k). For ease of understanding, user file 1 [0, 4k) is used as an example. 0 represents a start position of user file 1, and 4k represents an end position of user file 1, where 1k represents 1024 bytes, that is, user file 1 [0, 4k) represents a data block from the 0th byte of user file 1 to the 4096th byte (excluding the 4096th byte) of user file 1. In other words, it may also be referred to as an interval of the first 4096 bytes of user file 1. It is assumed that user file 3 [0, 4k) is an invalid interval, that is, only user file 1 [0, 4k), user file 2 [0, 4k), and user file 1 [4k, 8k) are valid. For the same user file (that is, user files with the same file identification), there may be a case of scattered writing in the first target file, that is, there are multiple address intervals. For example, the foregoing user file 1 [0, 4k) and user file 1 [4k, 8k) belong to the same user file 1. In this case, user file 1 [0, 4k) and user file 1 [4k, 8k) may be aggregated to obtain user file 1 [0, 8k).
Step b: writing the first valid data corresponding to each user file included in the first target file into the second log file in the second sub-interval. Specifically, the first valid data corresponding to each user file may be written into the second log file in the second sub-interval in sequence based on a label sorting of each user file. For example, the foregoing aggregated user file 1 [0, 8k) and user file 2 [0, 4k) may be written into the second log file in the second sub-interval in sequence. It should be noted that if user file 1 [0, 4k), user file 2 [0, 4k), and user file 1 [4k, 8k) are written into the second log file in sequence without aggregation, it will cause inconvenience and time-consuming in subsequent data reading. For example, if user file 1 [0, 8k) needs to be read, user file 1 [0, 4k), user file 2 [0, 4k), and user file 1 [4k, 8k) need to be read in sequence, that is, an unnecessary user file 2 [0, 4k) needs to be read, so that data of user file 1 [0, 8k) may be obtained. The above disadvantages are fully considered in the embodiments of the present disclosure, and therefore valid data is aggregated in units of user files, and then the first valid data corresponding to each aggregated user file is written into the second log file. For example, the first valid data is written into the second log file in the sequence of user file 1 [4k, 8k) and user file 2 [0, 4k), thereby improving read and write efficiency.

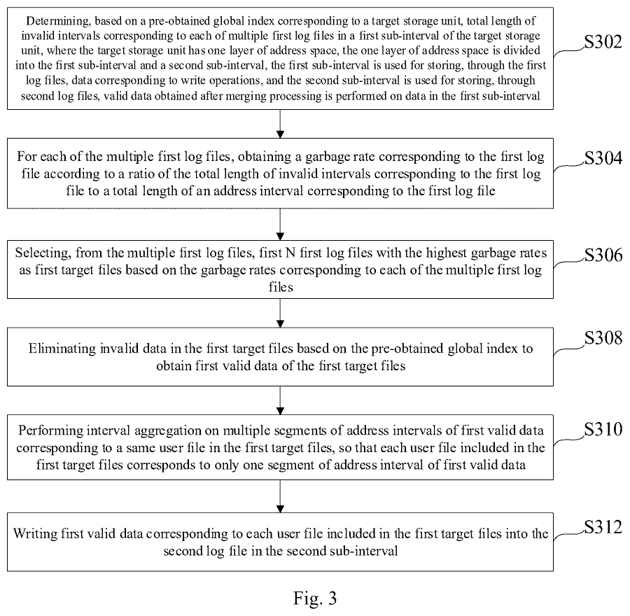

On the foregoing basis, taking the specified information being the garbage rate as an example, an embodiment of the present disclosure provides the schematic flowchart of a data merging method based on file storage shown in FIG. 3, which mainly includes the following steps S302 to S312.
Step S302: determining, based on a pre-obtained global index corresponding to a target storage unit, total length of invalid intervals corresponding to each of multiple first log files in a first sub-interval of the target storage unit, where the target storage unit has one layer of address space, the one layer of address space is equally divided into the first sub-interval and a second sub-interval, the first sub-interval is used for storing, through the first log files, data corresponding to write operations, and the second sub-interval is used for storing, through second log files, valid data obtained after merging processing is performed on data in the first sub-interval.
Step S304: for each of the multiple first log files, obtaining a garbage rate corresponding to the first log file according to a ratio of the total length of invalid intervals corresponding to the first log file to a total length of an address interval corresponding to the first log file.
Step S306: selecting, from the multiple first log files, first N first log files with the highest garbage rates as first target files based on the garbage rates corresponding to each of the multiple first log files. [0060] Step S308: eliminating invalid data in the first target files based on the pre-obtained global index to obtain first valid data of the first target files.
Step S310: performing interval aggregation on multiple segments of address intervals of first valid data corresponding to a same user file in the first target files, so that each user file included in the first target files corresponds to only one segment of address interval of first valid data.
Step S312: writing first valid data corresponding to each user file included in the first target files into the second log file in the second sub-interval.

For the specific content of the foregoing steps S302 to S312, reference may be made to the foregoing related content, and details are not repeated herein. Through the above method, the target storage unit having a new storage structure is used, and there is no problem like in the related art that data merging in other layers is blocked due to flipping. Moreover, on the basis of the target storage unit, a file garbage rate may be accurately calculated, and a first target file with a high garbage rate is preferentially selected for data merging processing, thereby improving data merging efficiency. In addition, the method of determining the valid data of the first target file based on the global index also avoids the problem of low merging processing efficiency caused by still using invalid data as valid data in a local range, and further improves merging processing efficiency. In addition, the manner of interval aggregation also facilitates improvement of data read and write efficiency.

Further, the embodiments of the present disclosure fully consider that because data is constantly written into the first sub-interval, and the first sub-interval is also merged in batches, and obtained valid data is stored into the second sub-interval, there may be the problem that some data written subsequently overwrites some data previously stored in the second sub-interval, resulting in invalid data still appearing in the second log file in the second sub-interval, that is, there may still be garbage data in the second sub-interval. To further improve resource utilization, the above method provided in the embodiments of the present disclosure may further perform merging processing on data in the second log file in the second sub-interval, which specifically includes the following steps 1 to 4.
Step 1: obtaining specified information about each existing second log file in the second sub-interval, where the specified information may be, for example, a garbage rate.
Step 2: selecting a second target file from the existing second log files based on the specified information about each of the existing second log files. For example, the second log files in the second sub-interval are sorted in descending order of garbage rate, and first M second log files with the highest garbage rates are selected as second target files. For details, reference may be made to the foregoing method of selecting the first target file from the first log files, which is not repeated herein.
Step 3: performing merging processing on data in the second target file to obtain second valid data. For details, reference may be made to the foregoing method of performing merging processing on the data in the first target file, which is not repeated herein.
Step 4: writing the second valid data into a latest created second log file in the second sub-interval. It may be understood that the second sub-interval usually includes multiple second log files, and after the existing second target file is merged, the obtained second valid data may be written into the latest created second log file, and after the writing is successful, the original second target file may be deleted.

Through the above method, the second log file in the second sub-interval may be merged efficiently and reliably, which also facilitates further improvement of resource utilization of the second sub-interval and reduction of redundancy of the second sub-interval.

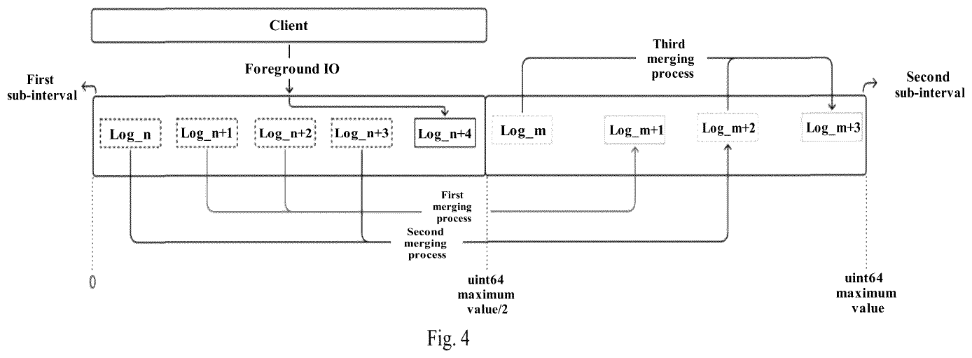

For ease of understanding, an embodiment of the present disclosure provides a data merging example, which may be seen from the schematic diagram of data merging shown in FIG. 4, showing that the target storage unit is divided into a first sub-interval with an interval range of 0 to uint64 maximum value/2 and a second sub-interval with an interval range of uint64 maximum value/2 to uint64 maximum value. The first sub-interval illustrates several first log files, which are Log_n, Log_n+1, Log_n+2, Log_n+3, and Log_n+4, respectively. It is assumed that Log_n, Log_n+1, Log_n+2, and Log_n+3 are full, and foreground IO data is written into Log_n+4. The second sub-interval illustrates several second log files, which are Log_m, Log_m+1, Log_m+2, and Log_m+3, respectively. Through the foregoing method, the first target files selected in the first merging process are Log_n+1 and Log_n+2. The first data merging process is performed on Log_n+1 and Log_n+2, obtained first valid data is written into Log_m+1, and then Log_n+1 and Log_n+2 may be cleared (therefore, they are represented by dotted lines in FIG. 4). The first target files selected in the second merging process are Log_n and Log_n+3. The second data merging process is performed on Log_n and Log_n+3, and obtained first valid data is written into Log_m+2. In addition, as described above, the merging processing may also be performed on the data in the second sub-interval. It is assumed that the second target files selected in the third merging process are Log_m and Log_m+2. The third data merging process is performed on Log_m and Log_m+2, and obtained second valid data is written into the current latest Log_m+3, and then Log_m and Log_m+2 may be cleared (therefore, they are represented by dotted lines in FIG. 4). For the specific implementation of the above example, reference may be made to the foregoing related content, and details are not repeated herein.

In conclusion, the data merging method based on file storage provided in the embodiments of the present disclosure uses the target storage unit having a new storage structure, which makes the structure more streamlined. On this basis, the problem in the related art that data merging in other layers is blocked due to flipping may be effectively avoided, and timeliness of the merging processing may be improved. Moreover, compared with the related art in which log files need to be selected from front to back for merging processing, the above method provided in the embodiments of the present disclosure may select, for example, a log file with the highest garbage rate for merging processing as needed, which is more flexible and helps improve data merging efficiency. In addition, the method of determining the valid data of the first target file based on the global index effectively avoids the problem of low merging processing efficiency caused by still using invalid data as valid data in a local range in the related art, and may further improve data merging efficiency.

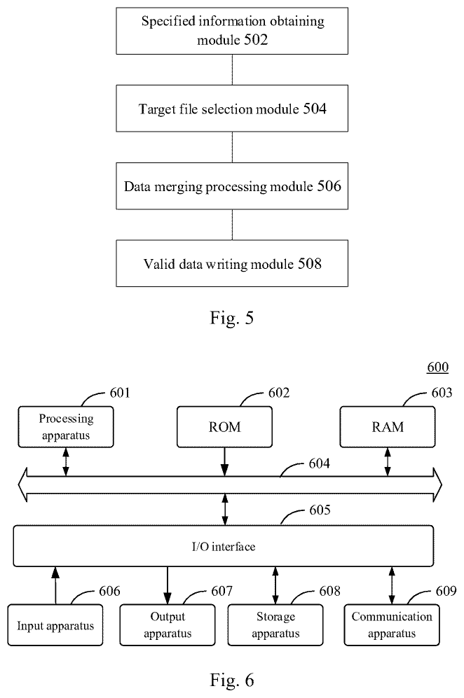

Corresponding to the data merging method based on file storage, an embodiment of the present disclosure further provides a data merging apparatus based on file storage. FIG. 5 is a schematic structural diagram of a data merging apparatus based on file storage according to an embodiment of the present disclosure. The apparatus may be implemented in software and/or hardware, and may generally be integrated into an electronic device. As shown in FIG. 5, the data merging apparatus includes:
a specified information obtaining module 502 configured to obtain specified information about each of multiple first log files in a first sub-interval of a target storage unit, where the target storage unit has one layer of address space, the one layer of address space is divided into the first sub-interval and a second sub-interval, the first sub-interval is used for storing, through the first log files, data corresponding to write operations, and the second sub-interval is used for storing valid data obtained after merging processing is performed on data in the first sub-interval;
a target file selection module 504 configured to select a first target file from the multiple first log files based on the specified information about each of the multiple first log files;
a data merging processing module 506 configured to perform merging processing on data in the first target file to obtain first valid data; and
a valid data writing module 508 configured to write the first valid data into a second log file in the second sub-interval.

According to the above technical solution provided in the embodiments of the present disclosure, full consideration is given to the fact that a storage unit structure of a traditional log-structured file system adopts multi-layer address space, and data merging may be performed only from front to back in each layer of address space, which is poor in flexibility and likely to affect merging efficiency. Moreover, the multi-layer address space adopted in an existing system has complex flip logic in design, and a flip process may also block data merging processing of other layers, which also greatly affects data merging efficiency. To this end, an embodiment of the present disclosure proposes a target storage unit adopting a new storage structure. The target storage unit has only one layer of address space, and the one layer of address space is divided into two sub-intervals with different functions, where the first sub-interval is used for storing, through the first log files, data corresponding to write operations, and the second sub-interval is used for storing, through second log files, valid data obtained after the merging processing is performed on the data in the first sub-interval. The above structure is more streamlined, and in this structure, a required first target file may be flexibly selected for merging processing based on the specified information about each of the multiple first log files. Compared with the related art in which data merging may be performed only from front to back, the above data merging mode is more flexible, which facilitates improvement of merging efficiency. Moreover, in the above structure, valid data in the first sub-interval in the same layer of address space is written into the second sub-interval, and there is no problem like in the related art that data merging in other layers is blocked due to flipping. Compared with the related art, data merging efficiency may be effectively improved.

In some implementations, the specified information includes a garbage rate, a degree of data dispersion, or an access frequency.

In some implementations, in the case where the specified information includes the garbage rate, the specified information obtaining module 502 is further configured to: determine, based on a pre-obtained global index corresponding to the target storage unit, total length of invalid intervals corresponding to each of the multiple first log files in the first sub-interval of the target storage unit; and for each of the multiple first log files, obtain a garbage rate corresponding to the first log file according to a ratio of the total length of invalid intervals corresponding to the first log file to a total length of an address interval corresponding to the first log file.

In some implementations, the target file selection module 504 is further configured to: based on a value corresponding to the specified information about each of the multiple first log files, select, from the multiple first log files, first N first log files with the highest values corresponding to the specified information as target log files, or select, from the multiple first log files, a first log file with a value corresponding to the specified information higher than a preset threshold as the first target file, where N is a preset positive integer. [0081] In some implementations, the data merging processing module 506 is further configured to: eliminate invalid data in the first target file based on a pre-obtained global index corresponding to the target storage unit to obtain the first valid data of the first target file.

In some implementations, the valid data writing module 508 is further configured to: perform interval aggregation on multiple segments of address intervals of first valid data corresponding to a same user file in the first target file, so that each user file included in the first target file corresponds to only one segment of address interval of first valid data, and address intervals corresponding to different user files are different; and write first valid data corresponding to each user file included in the first target file into the second log file in the second sub-interval.

In some implementations, the apparatus further includes a second writing module configured to: obtain specified information about each existing second log file in the second sub-interval; select a second target file from the existing second log files based on the specified information about each of the existing second log files; perform merging processing on data in the second target file to obtain second valid data; and write the second valid data into a latest created second log file in the second sub-interval.

In some implementations, an interval length corresponding to the first sub-interval is the same as an interval length corresponding to the second sub-interval.

The data merging apparatus based on file storage provided in the embodiments of the present disclosure may perform the data merging method based on file storage provided in any embodiment of the present disclosure, and has corresponding functional modules and beneficial effects for performing the method.

Those skilled in the art may clearly understand that, for the convenience and simplicity of description, for the specific working process of the apparatus embodiment described above, reference may be made to the corresponding process in the method embodiment, and details are not repeated herein.

An embodiment of the present disclosure provides an electronic device. The electronic device includes: a storage apparatus having a computer program stored thereon; and a processing apparatus configured to execute the computer program in the storage apparatus to implement the steps of any method in the present disclosure.

Reference is made to FIG. 6 below, which illustrates a schematic structural diagram of an electronic device 600 suitable for implementing the embodiments of the present disclosure. The terminal device in the embodiments of the present disclosure may include, but is not limited to, a mobile terminal such as a mobile phone, a notebook computer, a digital broadcast receiver, a personal digital assistant (PDA), a portable application device (PAD, tablet computer), a portable media player (PMP), and an in-vehicle terminal (such as an in-vehicle navigation terminal), and a stationary terminal such as a digital television and a desktop computer. The electronic device shown in FIG. 6 is only an example, and should not impose any limitation on the function and scope of use of the embodiments of the present disclosure.

As shown in FIG. 6, the electronic device 600 may include a processing apparatus (such as a central processing unit and a graphics processing unit) 601, which may perform various appropriate actions and processing according to a program stored in a read-only memory (ROM) 602 or a program loaded from a storage apparatus 608 into a random access memory (RAM) 603. The RAM 603 further stores various programs and data required for operations of the electronic device 600. The processing apparatus 601, the ROM 602, and the RAM 603 are interconnected by means of a bus 604. An input/output (I/O) interface 605 is also connected to the bus 604.

Usually, the following apparatuses may be connected to the I/O interface 605: an input apparatus 606 including, for example, a touch screen, a touchpad, a keyboard, a mouse, a camera, a microphone, an accelerometer, and a gyroscope; an output apparatus 607 including, for example, a liquid crystal display (LCD), a speaker, and a vibrator; the storage apparatus 608 including, for example, a magnetic tape and a hard disk; and a communication apparatus 609. The communication apparatus 609 may allow the electronic device 600 to perform wireless or wired communication with other devices to exchange data. Although FIG. 6 shows the electronic device 600 having various apparatuses, it should be understood that not all the apparatuses shown here need to be implemented or provided. More or fewer apparatuses may alternatively be implemented or provided.

In particular, according to the embodiments of the present disclosure, the process described above with reference to the flowcharts may be implemented as a computer software program. For example, the embodiments of the present disclosure include a computer program product, which includes a computer program carried on a non-transitory computer-readable medium, where the computer program includes program code for performing the method shown in the flowchart. In such an embodiment, the computer program may be downloaded and installed from a network through the communication apparatus 609, or installed from the storage apparatus 608, or installed from the ROM 602. When the computer program is executed by the processing apparatus 601, the foregoing functions defined in the method of the embodiments of the present disclosure are executed.

In addition to the above methods and devices, the embodiments of the present disclosure may also be computer program products, which include computer program instructions that, when executed by a processor, cause the processor to execute the methods provided in the embodiments of the present disclosure. The computer program product may be written in any combination of one or more programming languages to execute the program code of the operations of the embodiments of the present disclosure. The programming languages include object-oriented programming languages such as Java, C++, and conventional procedural programming languages such as “C” language or similar programming languages. The program code may be executed entirely on a user computing device, partly on a user device, as a stand-alone software package, partly on a user computing device and partly on a remote computing device, or entirely on a remote computing device or server.

In addition, an embodiment of the present disclosure may also be a computer-readable storage medium having computer program instructions stored thereon, where the computer program instructions, when executed by a processor, cause the processor to execute the data merging method provided in the embodiments of the present disclosure.

The computer-readable storage medium may adopt any combination of one or more readable media. The readable medium may be a readable signal medium or a readable storage medium. The readable storage medium may include, for example, but is not limited to, an electronic, magnetic, optical, electromagnetic, infrared, or semiconductor system, apparatus, or device, or any suitable combination of the above. More specific examples (a non-exhaustive list) of the readable storage medium include: an electrically connected portable disk having one or more wires, a portable disk, a hard disk, a random access memory, a read-only memory, an erasable programmable read-only memory, an optical fiber, a portable compact disk read-only memory, an optical storage device, a magnetic storage device, or any suitable combination of the above.

An embodiment of the present disclosure further provides a computer program product including a computer program/instruction that, when executed by a processor, implements the data merging method in the embodiments of the present disclosure.

It may be understood that before the technical solutions disclosed in the embodiments of the present disclosure are used, the user shall be informed of the type, range of use, use scenarios, etc., of personal information involved in the present disclosure in an appropriate manner in accordance with relevant laws and regulations, and the authorization of the user shall be obtained.

For example, in response to receiving an active request from a user, prompt information is sent to the user to clearly inform the user that the requested operation will require access to and use of the user's personal information. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to choose whether to “agree” or “disagree” to provide the personal information to the electronic device.

It may be understood that the above process of notifying and obtaining user authorization is only illustrative and does not limit the implementations of the present disclosure. Other methods that satisfy relevant laws and regulations may also be applied to the implementations of the present disclosure.

It should be noted that in this paper, relational terms such as “first” and “second” are only used to distinguish one entity or operation from another entity or operation, and do not necessarily require or imply any actual relationship or order between these entities or operations. Moreover, the terms “include”, “include”, or any other variation thereof are intended to cover non-exclusive inclusion, so that a process, method, object, or device that includes a list of elements includes not only those elements, but also other elements not explicitly listed or elements inherent to such process, method, object, or device. Without further restrictions, an element defined by the phrase “includes a . . . ” does not exclude the existence of other identical elements in the process, method, object, or device that includes the element.

The above descriptions are only specific implementations of the present disclosure, so that those skilled in the art may understand or implement the present disclosure. Various modifications to these embodiments will be readily apparent to those skilled in the art, and the generic principles defined herein may be implemented in other embodiments without departing from the spirit or scope of the present disclosure. Therefore, the present disclosure will not be limited to the embodiments described herein, but rather to the widest scope consistent with the principles and novel features disclosed herein.

1. A data merging method based on file storage, comprising:
obtaining specified information about each of a plurality of first log files in a first sub-interval of a target storage unit, wherein the target storage unit has one layer of address space, and the one layer of address space is divided into the first sub-interval and a second sub-interval, the first sub-interval is configured for storing, through the first log files, data corresponding to write operations, and the second sub-interval is configured for storing, through second log files, valid data obtained after merging processing is performed on data in the first sub-interval;
selecting a first target file from the plurality of first log files based on the specified information about each of the plurality of first log files;
performing merging processing on data in the first target file to obtain first valid data;
and writing the first valid data into a second log file in the second sub-interval.

2. The method of claim 1, wherein the specified information comprises a garbage rate, a degree of data dispersion, or an access frequency.

3. The method of claim 2, wherein in response to that the specified information comprises the garbage rate, the obtaining specified information about each of the plurality of first log files in the first sub-interval of the target storage unit comprises:
determining, based on a pre-obtained global index corresponding to the target storage unit, total length of invalid intervals corresponding to each of the plurality of first log files in the first sub-interval of the target storage unit; and
for each of the plurality of first log files, obtaining the garbage rate corresponding to the first log file according to a ratio of the total length of invalid intervals corresponding to the first log file to a total length of an address interval corresponding to the first log file.

4. The method of claim 2, wherein the selecting the first target file from the plurality of first log files based on the specified information about each of the plurality of first log files comprises:
based on a value corresponding to the specified information about each of the plurality of first log files, selecting, from the plurality of first log files, first N first log files with the highest values corresponding to the specified information as the first target file, or selecting, from the plurality of first log files, a first log file with a value corresponding to the specified information higher than a preset threshold as the first target file, wherein N is a preset positive integer.

5. The method of claim 1, wherein the performing merging processing on data in the first target file to obtain the first valid data comprises:
eliminating invalid data in the first target file based on a pre-obtained global index corresponding to the target storage unit to obtain the first valid data of the first target file.

6. The method of claim 1, wherein the writing the first valid data into the second log file in the second sub-interval comprises:
performing interval aggregation on a plurality of segments of address intervals of the first valid data corresponding to a same user file in the first target file, so that each user file comprised in the first target file corresponds to only one segment of address interval of the first valid data; and
writing first valid data corresponding to each user file comprised in the first target file into the second log file in the second sub-interval.

7. The method of claim 1, further comprising:
obtaining specified information about each existing second log file in the second sub-interval;
selecting a second target file from the existing second log files based on the specified information about each of the existing second log files;
performing merging processing on data in the second target file to obtain second valid data; and
writing the second valid data into a latest created second log file in the second sub-interval.

8. The method of claim 1, wherein an interval length corresponding to the first sub-interval is the same as an interval length corresponding to the second sub-interval.

9. An electronic device, comprising:
a storage apparatus having a computer program stored thereon; and
a processing apparatus configured to execute the computer program in the storage apparatus to implement a data merging method based on file storage, comprising:
obtaining specified information about each of a plurality of first log files in a first sub-interval of a target storage unit, wherein the target storage unit has one layer of address space, and the one layer of address space is divided into the first sub-interval and a second sub-interval, the first sub-interval is configured for storing, through the first log files, data corresponding to write operations, and the second sub-interval is configured for storing, through second log files, valid data obtained after merging processing is performed on data in the first sub-interval;
selecting a first target file from the plurality of first log files based on the specified information about each of the plurality of first log files;
performing merging processing on data in the first target file to obtain first valid data;
and writing the first valid data into a second log file in the second sub-interval.

10. The electronic device of claim 9, wherein the specified information comprises a garbage rate, a degree of data dispersion, or an access frequency.

11. The electronic device of claim 10, wherein in response to that the specified information comprises the garbage rate, the obtaining specified information about each of the plurality of first log files in the first sub-interval of the target storage unit comprises:
determining, based on a pre-obtained global index corresponding to the target storage unit, total length of invalid intervals corresponding to each of the plurality of first log files in the first sub-interval of the target storage unit; and
for each of the plurality of first log files, obtaining the garbage rate corresponding to the first log file according to a ratio of the total length of invalid intervals corresponding to the first log file to a total length of an address interval corresponding to the first log file.

12. The electronic device of claim 10, wherein the selecting the first target file from the plurality of first log files based on the specified information about each of the plurality of first log files comprises:
based on a value corresponding to the specified information about each of the plurality of first log files, selecting, from the plurality of first log files, first N first log files with the highest values corresponding to the specified information as the first target file, or selecting, from the plurality of first log files, a first log file with a value corresponding to the specified information higher than a preset threshold as the first target file, wherein N is a preset positive integer.

13. The electronic device of claim 9, wherein the performing merging processing on data in the first target file to obtain the first valid data comprises:
eliminating invalid data in the first target file based on a pre-obtained global index corresponding to the target storage unit to obtain the first valid data of the first target file.

14. The electronic device of claim 9, wherein the writing the first valid data into the second log file in the second sub-interval comprises:
performing interval aggregation on a plurality of segments of address intervals of the first valid data corresponding to a same user file in the first target file, so that each user file comprised in the first target file corresponds to only one segment of address interval of the first valid data; and
writing first valid data corresponding to each user file comprised in the first target file into the second log file in the second sub-interval.

15. A non-statutory computer-readable storage medium storing a computer program, wherein the computer program is configured to perform a data merging method based on file storage, comprising:
obtaining specified information about each of a plurality of first log files in a first sub-interval of a target storage unit, wherein the target storage unit has one layer of address space, and the one layer of address space is divided into the first sub-interval and a second sub-interval, the first sub-interval is configured for storing, through the first log files, data corresponding to write operations, and the second sub-interval is configured for storing, through second log files, valid data obtained after merging processing is performed on data in the first sub-interval;
selecting a first target file from the plurality of first log files based on the specified information about each of the plurality of first log files;
performing merging processing on data in the first target file to obtain first valid data;
and writing the first valid data into a second log file in the second sub-interval.

16. The non-statutory computer-readable storage medium of claim 15, wherein the specified information comprises a garbage rate, a degree of data dispersion, or an access frequency.

17. The non-statutory computer-readable storage medium of claim 16, wherein in response to that the specified information comprises the garbage rate, the obtaining specified information about each of the plurality of first log files in the first sub-interval of the target storage unit comprises:
determining, based on a pre-obtained global index corresponding to the target storage unit, total length of invalid intervals corresponding to each of the plurality of first log files in the first sub-interval of the target storage unit; and
for each of the plurality of first log files, obtaining the garbage rate corresponding to the first log file according to a ratio of the total length of invalid intervals corresponding to the first log file to a total length of an address interval corresponding to the first log file.

18. The non-statutory computer-readable storage medium of claim 16, wherein the selecting the first target file from the plurality of first log files based on the specified information about each of the plurality of first log files comprises:
based on a value corresponding to the specified information about each of the plurality of first log files, selecting, from the plurality of first log files, first N first log files with the highest values corresponding to the specified information as the first target file, or selecting, from the plurality of first log files, a first log file with a value corresponding to the specified information higher than a preset threshold as the first target file, wherein N is a preset positive integer.

19. The non-statutory computer-readable storage medium of claim 15, wherein the performing merging processing on data in the first target file to obtain the first valid data comprises:
eliminating invalid data in the first target file based on a pre-obtained global index corresponding to the target storage unit to obtain the first valid data of the first target file.

20. The non-statutory computer-readable storage medium of claim 15, wherein the writing the first valid data into the second log file in the second sub-interval comprises:
performing interval aggregation on a plurality of segments of address intervals of the first valid data corresponding to a same user file in the first target file, so that each user file comprised in the first target file corresponds to only one segment of address interval of the first valid data; and
writing first valid data corresponding to each user file comprised in the first target file into the second log file in the second sub-interval.
